(19) United States
(12) Patent Application Publication
(10) Pub. No.: US 2004/0004017 A1
(43) Pub. Date: Jan. 8, 2004

(54) Measuring and storage container

(76) Inventor: Lisa Schmitt, Lake Oswego, OR (US)

Correspondence Address: Garth Janke, BIRDWELL, JANKE & DURANDO, PLC, 1100 SW Sixth Avenue, Suite 1400, Portland, OR, 97204, US

(21) Appl. No.: 10/644,551

(22) Filed: Aug. 20, 2003

(51) Int. Cl. B65B 61/26; B65B 61/00; B65D 79/00; A23L 1/025

(52) U.S. Cl. 206/459.5; 426/383; 426/393

(57) ABSTRACT

A measuring and storage container. The container includes one or more compartments for receiving respective portions of a substance. The compartments bear respective indicia indicating the position of at least one fill level. The fill level for a compartment is at an elevation below a maximum filling elevation for the compartment.

The present invention relates to a measuring and storage container, particularly such a container that is used for measuring and storing food in the home.

### BACKGROUND OF THE INVENTION

Measuring cups have long been available for measuring liquid substances as well as particulate or granulated solid substances such as flour and sugar for baking purposes. The measuring cup is used to introduce a desired quantity of the substance into another container for mixing with other substances, or for storage.

Where the measured quantities are used for formulating food substances in the home, the mixing is typically performed in a container that is used for cooking the mixture, such as a cake, cookie or pie pan. The mixture typically expands upon heating and may rise above the level of the container.

Analogous to such containers used for processing food by heating or cooking, an exemplary container used for processing food by cooling or freezing is the ice cube tray. Typically, measured quantities are not provided to ice cube trays; rather, the ice cube tray is simply filled nearly to the top. Since water or other aqueous liquid substances expand in the transformation from the liquid to the solid phase, the substance may rise above the level of the ice cube tray upon freezing. However, as a practical matter, it is unusual to fill an ice cube tray to such a high level that this would occur since the ice cube tray must typically be carried to and put in the freezer without spilling the contents.

After a food has been processed by cooking, it is typically removed from the processing container and placed on or in a storage container. Typically such storage containers are formed of glass or plastic and include lids for sealing the contents of the container.

The ice cube tray used for processing food by cooling or freezing is typically also used as a storage container for the cooled or frozen food, where it may be noted that ice cube trays have been used for cooling and storing liquid/solid mixtures such as chicken broth in addition to ice cubes.

As storage containers, ice cube trays provide some unique advantages. For example, when formed of plastic, ice cube trays typically provide the capability to remove frozen substances stored therein simply by twisting the tray. Since the tray is relatively flexible compared to the frozen substance in the tray, the distortion of the tray when twisted permits separation of the tray from the relatively rigid frozen substance, so that the frozen substance can be easily removed from the tray. Ice cube trays are also typically formed so that they can be stacked, even when the trays are filled with liquid, so that the bottom of a stacked upper tray does not interfere with the liquid in the lower tray, and so that the stacked trays are mechanically stable in the freezer. As with storage containers generally, ice cube trays may be provided with snap-on lids which serve the particular purpose in the case of the ice cube tray to stop odors and to prevent freezer burn.

There has been an increasing level of interest in apportioning foods prepared in the home, particularly for dieters. Many diet plans place rigorous limitations on quantities of food intake and adjust the limitations specifically for each type of food consumed. The dieter typically must employ a measuring container to obtain a desired portion, and thereafter remove the portion from the measuring container so that it can be placed into a storage container. While transferring food substances from a measuring container to a processing or storage container is commonly necessary in food processing such as baking, it represents an additional step incurred by the dieter in the mere storage of food. Accordingly, there is a need for a novel and improved measuring and storage container, particularly such a container that is used for measuring and storing food in the home.

### SUMMARY OF THE INVENTION

A preferred embodiment of a measuring and storage container according to the present invention includes a plurality of compartments for receiving respective portions of a substance. The compartments bear respective indicia indicating the position of at least one fill level. The fill level for a compartment is at an elevation below a maximum filling elevation for the compartment.

In another embodiment of the invention, the container comprises at least one compartment for receiving a substance. The compartment bears indicia indicating the position of at least one fill level. The fill level is at an elevation below a maximum filling elevation for the compartment. A lid is adapted to snap-fit onto the container, over the compartment.

In yet another embodiment of the invention, the container is adapted to rest on a surface and provide a stable orientation of the container. The container comprises at least one compartment for receiving a substance. The compartment bears indicia indicating the position of at least one fill level. The fill level is at an elevation below a maximum filling elevation for the compartment. The container has a top surface and a complementary bottom surface adapted so that multiple instances of the container are stackable, whereby each of the multiple instances of the container is retained in the stable orientation.

Therefore, it is a principal object of the present invention to provide a novel and improved measuring and storage container.

The foregoing and other objects, features, and advantages of the invention will be more readily understood upon consideration of the following detailed description of the invention, taken in conjunction with the accompanying drawings.

### BRIEF DESCRIPTION OF THE DRAWINGS

FIG. 1 is a pictorial view of a measuring and storage container according to the present invention.

FIG. 2 is a pictorial view of a first alternative embodiment of a measuring and storage container according to the present invention, showing removable partitions.

FIG. 3 is a pictorial view of another alternative embodiment of a measuring and storage container according to the present invention, showing removable compartments.

FIG. 4 is a pictorial view of yet another embodiment of a measuring and storage container according to the present invention including a snap-on lid.

FIG. 5 is a cross-sectional view of two of the measuring and storage containers of FIG. 1 stacked together.

### DETAILED DESCRIPTION OF A PREFERRED EMBODIMENT

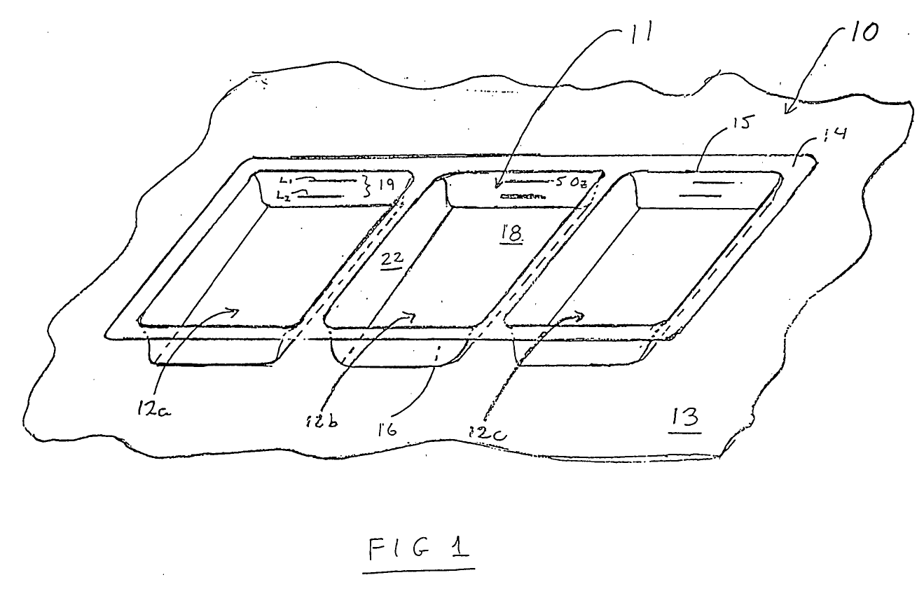

FIG. 1 shows a preferred embodiment of a measuring and storage container 10 according to the present invention. The container 10 may be used for containing any substance, but is preferably used for containing food for freezer storage in the home. The term “food” as used herein may refer to any edible solid or liquid, or mixture thereof, and includes water.

The container 10 has an open top side 11 through which food may be introduced into the container, and is adapted to rest on a level surface 13 in a stable orientation of the container for receiving the food. The container is preferably adapted to contain a liquid, but this may not be required when used for storing some types of food, and is preferably formed of plastic, but may be formed of glass or any other desired material.

The container 10 preferably includes a plurality of compartments 12 for storing respective portions of the food, e.g., compartments 12a, 12b, . . . 12n. Three compartments 12a, 12b and 12c are shown, however, the number of compartments can vary as desired. The container has a top surface 14 and each compartment has an exterior compartment bottom surface 16. The exterior compartment bottom surface 16 may be adapted for resting on the surface 13, or some other feature of the container 10 may be employed for this purpose. One or more sidewalls 22 of each compartment extend upwardly from an interior compartment bottom surface 18 toward the top surface 14.

The interior of each compartment also includes an indicium or indicia 19 (hereinafter “indicia”), indicating one or more fill levels “L.” Each fill level indicates a filling elevation for the compartments when the container is in the aforementioned stable orientation.

The indicia may be molded-in features of, or may be printed or embossed on the sidewall 22. They may be provided in any form capable of indicating level; however, preferably, they are lines of horizontal elevation such as shown in FIG. 1, where indicia providing for two fill levels “L₁” and “L₂” are shown. However, indicia may be limited to any geometric shape of sufficiently small size to be capable of indicating elevation with reasonable unambiguity, such as a small star-shape, or dimple. It may be preferable, in addition, to provide textual information indicating the quantity of the portion when filled to the level, e.g., “5 oz” (as shown in compartment 12b) or “100 cal” (where the portion is of a predetermined calorie content).

The fill levels “L” are above the respective interior compartment bottom surfaces 18 and below respective maximum filling elevations 15 of the compartments, where a level top surface 14 is shown as an example. In general, the maximum filling elevations are those above which portions provided in a liquid form, in compartments capable of containing the liquid, would overflow the respective compartments. Accordingly, something more than 0% and something less than 100% of the compartmental volume is planned for storage.

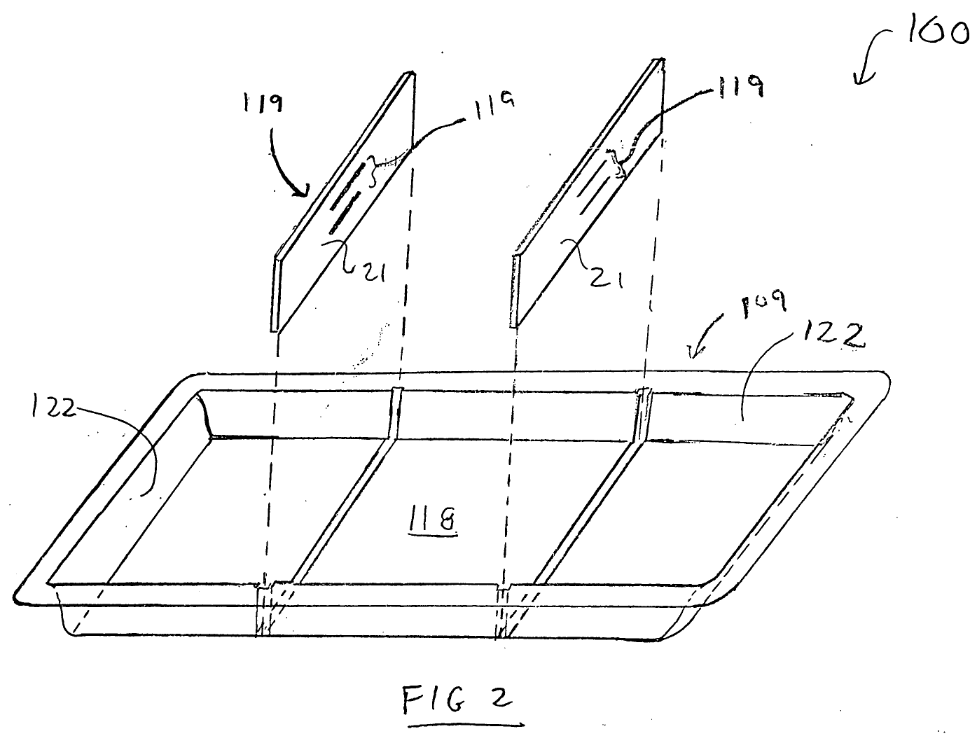

The compartments 12 are most economically and simply provided in a plastic embodiment of the container 10 by molding the container integrally. However, according to an alternative embodiment of the invention shown in FIG. 2, the compartments may be provided through the use of removable partitions 21. In a plastic embodiment of the container body 9, these partitions are also preferably formed of plastic.

A preferred container 100 for use with the partitions 21 as shown in FIG. 2 has a body portion 209, and four sidewalls 122 that extend upwardly from a single interior bottom surface 118 of the container. The sidewalls 122 and the bottom surface 118 are employed in conjunction with the partitions 21 to form the compartments of the container. Preferably, the sidewalls 122 and the interior compartment bottom surface 118 form a liquid-containing volume in the container 100. However, the partitions 21 need not provide impermeable seals between adjacent compartments because, typically, all of the compartments will be used to store the same type of food, so that inadvertent mixing of the portions will not be objectionable. Alternatively, the partitions may be adapted for a liquid-impermeable interference fit with, e.g., grooves in the container 100 if such compartmental segregation is desired. For the three compartments provided by the two partitions 21, at least three sets of indicia 119 may be provided by the partitions 21 to provide a convenient means for customizing the container 100 simply by changing the partitions.

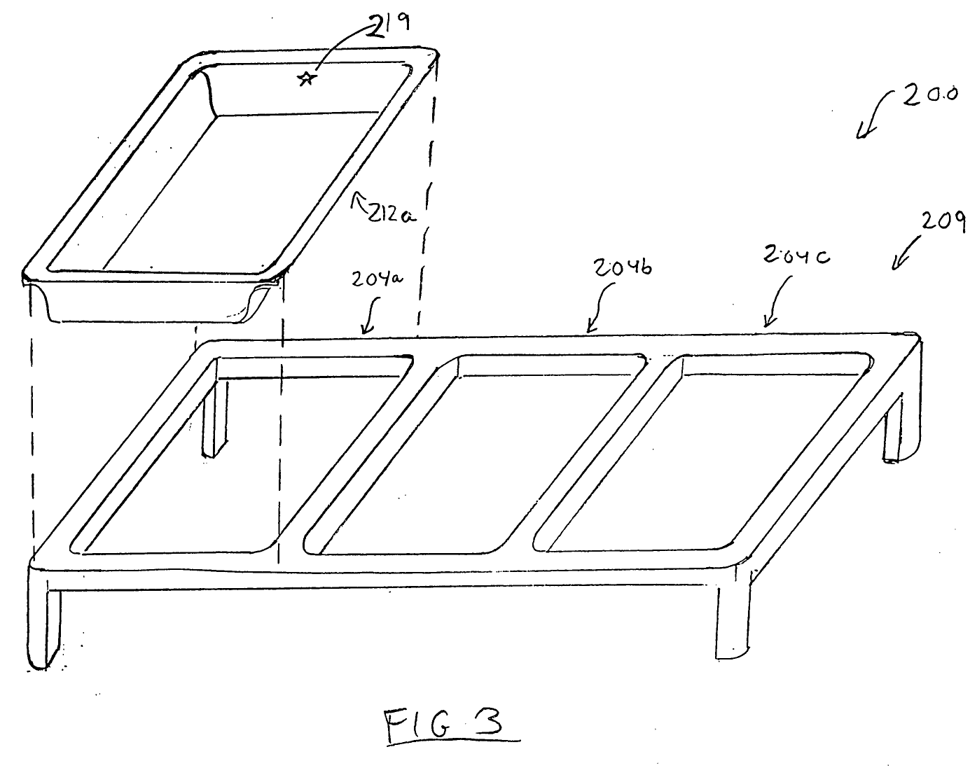

Another alternative container 200 according to the present invention is shown in FIG. 3. The container 200 has a body portion 209 defining receptacles 204a, 204b, . . . 204n (204a-204c shown) for receiving respective removable compartments 212a, 212, . . . 212n (212a shown). The removable compartments bear indicia 219, which in this example is a star design.

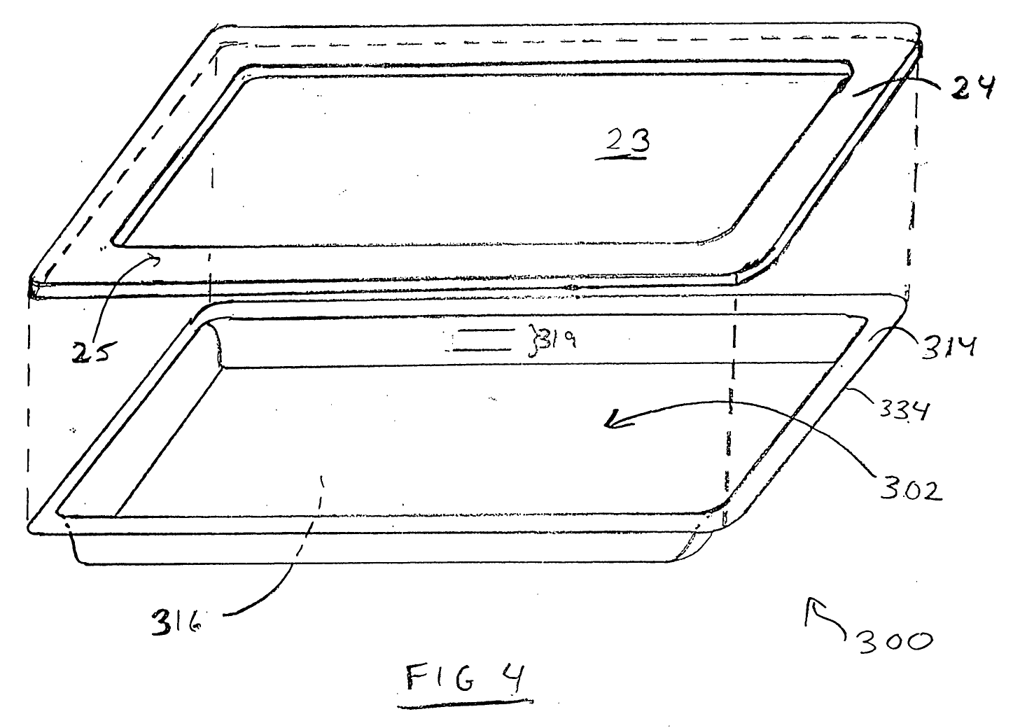

FIG. 4 shows a container 300 having a single compartment 302. The container 300 is provided with a snap-on lid 24, as may any of the containers described above. The lid 24 snap-fits onto the container 300 over the compartment 302, for sealing the compartment. In this example, the lid 24 snaps over the outside edge 334 of a top surface 314 of the container in such manner as will be readily understood by persons of ordinary mechanical skill. The container may have any number of additional compartments.

The lid 24 may be used to receive the exterior compartment bottom surface 316 of the compartment 302 of another instance of the container 300, for stacking two or more of the containers such that the containers are retained in their stable orientations. For example, an indentation 23 may be provided on a top surface 25 of the lid 24, where the indentation 23 is shaped to fit the contours of the exterior compartment bottom surface 316 of the compartment(s). A container according to the present invention provided in this configuration is referred to herein as being “stackable.” The container may be provided to be stackable in conjunction with use of the lid 24 in alternative embodiments as will be readily apparent to persons of ordinary skill.

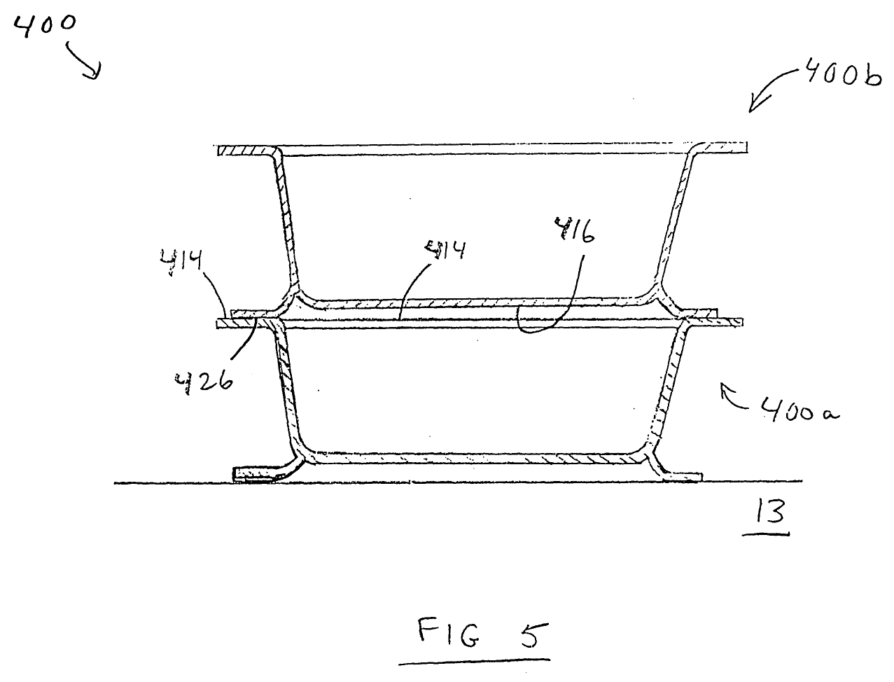

Preferably, measuring and storage containers according to the present invention are adapted to be stackable without a requirement to use a lid such as the lid 24. Referring to FIG. 5, in one embodiment of such a stackable container 400, the top surface 414 of a first instance of the container 400a is adapted to receive a container body bottom surface 426 of a second instance of the container 400b that is stacked on the container 400a such that no part of the exterior compartment bottom surface 416 of the container 400b extends below the top surface 414 of the container 400a. The container may be provided to be stackable without use of the lid 24 in alternative embodiments as will be readily apparent to persons of ordinary skill.

Typically, measuring and storage containers according to the present invention would be used by a home cook or a person who may be referred to as a “home chef” to signify a typically above-average interest in preparing food or cuisine in the home. It is often time consuming to prepare a component, e.g., spaghetti sauce, of an ultimate food dish or end food product, e.g., spaghetti. Accordingly, a home chef may wish to prepare a large quantity of the component for future food dishes. A measuring and storage container according to the present invention provides the outstanding advantage of providing measured quantities for storage in such a context. Typical uses for the containers would be in the preparation of food “from scratch”, and in diet and baby food preparation. In all of these uses, it is commonly desired to prepare a quantity of food at once that can be removed from storage over time in precisely measured portions.

For example, in diet food preparation and storage, the measuring and storage containers may be used for apportioning quantities of food planned for the diet The size, number of compartments, form of the compartments, and indicia used for the containers may be specially adapted for a particular diet and particular type of food. Additional versions of the containers may then be provided for other diets or for other types of food. Moreover, the containers may be further adapted for the caloric or other dietary goals of the dieter so that highly specialized versions of the containers varying by diet, food, and dietary goals can be provided. Preferably, in a general purpose measuring and storage container according to the present invention, a number of alternative fill levels are provided in the indicia, e.g., ¼, ½, ¾, and 1 cup.

Measuring and storage containers according to the present invention are preferably specially adapted for freezer storage of portions of food that are introduced into the container in liquid or semi-liquid form prior to freezing. Accordingly, the fill levels are preferably adjusted to compensate for volume changes as a result of freezing. For example, the highest fill level, i.e., the level “L₁” in FIG. 1, is preferably provided to be sufficiently below the surface 14 that when the compartment is filled with water to that level and thereafter frozen, the height of the frozen water remains at or below the maximum filling elevation 15. When the container is formed of plastic, the plastic is preferably formed in sufficiently thin cross-sections and the container is provided with appropriate exterior dimensions so that the containers can be easily twisted in the manner of the plastic ice-cube tray to facilitate removal of frozen contents.

It should be understood that, while a specific measuring and storage container and method of use thereof has been shown and described as preferred, other embodiments and variations, including those already mentioned, may be provided according to the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims that follow.

1. A measuring and storage container adapted to rest on a surface and provide a stable orientation of the container, comprising a plurality of compartments for receiving respective portions of a substance, said compartments defining respective maximum filling elevations thereof in said stable orientation of the container, said compartments bearing respective indicia indicating the position of at least one fill level, wherein said at least one fill level is at a level below the respective maximum filling elevation.

2. The measuring and storage container of claim 1, wherein the container is adapted to contain a liquid.

3. The measuring and storage container of claim 2, wherein the container is formed of plastic.

4. The measuring and storage container of claim 3, wherein said compartments are integrally molded with the container.

5. The measuring and storage container of claim 1, further comprising removable partitions defining said compartments.

6. The measuring and storage container of claim 1, wherein one of said at least one fill level is at an elevation that corresponds to the elevation at which ice reaching said maximum fill elevation would contract when melted.

7. The measuring and storage container of claim 1, wherein said container body has a top surface and a complementary bottom surface adapted so that multiple instances of the container are stackable so that each of said multiple instances of the container is retained in said stable orientation.

8. The measuring and storage container of claim 7, wherein each of said multiple instances of the container includes a respective lid adapted to snap-fit onto the container, thereby providing said top surface.

9. The measuring and storage container of claim 1, further comprising a lid adapted to snap-fit onto the container, over said compartments.

10. A measuring and storage container adapted to rest on a surface and provide a stable orientation of the container, comprising:
at least one compartment for receiving a substance, said compartment defining a maximum filling elevation thereof in said stable orientation of the container, said compartment bearing indicia indicating the position of at least one fill level, wherein said at least one fill level is at a level below said maximum filling elevation; and
a lid adapted to snap-fit onto the container, over said compartment.

11. The measuring and storage container of claim 10, wherein the container has a bottom surface complementary to said lid adapted so that multiple instances of the container with said lid fitted thereon are stackable, whereby each of said multiple instances of the container is retained in said stable orientation.

12. A measuring and storage container adapted to rest on a surface and provide a stable orientation of the container, comprising at least one compartment for receiving a substance, said compartment defining a maximum filling elevation thereof in said stable orientation of the container, said compartment bearing indicia indicating the position of at least one fill level, wherein said at least one fill level is at a level below said maximum filling elevation, wherein the container has a top surface and a complementary bottom surface adapted so that multiple instances of the container are stackable, whereby each of said multiple instances of the container is retained in said stable orientation.

13. A method of measuring and storing food, comprising the steps of:
providing a container having at least one compartment for receiving a substance, said compartment defining a maximum filling elevation thereof, said compartment bearing indicia indicating the position of at least one fill level, wherein said at least one fill level is at a level below said maximum filling elevation;
filling said compartment with the food to said at least one fill level through said open top; and
thereafter storing the container in a freezer, thereby freezing the food in said compartment.

14. A method of measuring and storing portions of food, comprising the steps of:
providing a measuring and storage container adapted to rest on a surface and provide a stable orientation of the container, the container comprising a plurality of compartments for receiving respective portions of a substance through an open top side of the container, said compartments defining respective maximum filling elevations thereof in said stable orientation of the container, said compartments bearing respective indicia indicating the position of at least one fill level, wherein said at least one fill level is at a level below the respective maximum filling elevation; and
filling said compartments with respective portions of the food to, respectively, said at least one fill level through said open top side of the container.

15. The method of claim 14, further comprising thereafter storing said container in a freezer, thereby freezing the portions of food in said compartments.
